(19) United States
(12) Patent Application Publication
(10) Pub. No.: US 2012/0177773 A1
(43) Pub. Date: Jul. 12, 2012

(54) Electric Injection Molding Machine

(76) Inventor: Shou-Jen Huang, New Taipei City (TW)

(21) Appl. No.: 13/330,762

(22) Filed: Dec. 20, 2011

(30) Foreign Application Priority Data
Jan. 7, 2011 (TW) 100100601

(51) Int. Cl. B29C 45/64; B29C 45/20; B29C 45/26; B29C 45/12

(52) U.S. Cl. 425/542

(57) ABSTRACT

An electric injection molding machine has a base, multiple connecting rods, a first driving device and a second driving device. The base has a first fixed board, a first moving board, a second moving board and a second fixed board. The connecting rods are mounted respectively through the first fixed board, first moving board, second moving board and second fixed board. The first driving device is mounted between the first fixed board and first moving board and has a first servomotor. The second driving device is mounted between the second moving board and second fixed board and has a second servomotor. The two servomotors provide sufficient strength and speed so operation of the electric injection molding machine is efficient and smooth.

### BACKGROUND OF THE INVENTION

1. Field of the Invention

The present invention relates to an injection molding machine, and more particularly to an electric injection molding machine that has two servomotors to enhance power applied to the injection molding machine and improve efficiency of the operation of the injection molding machine.

2. Description of the Prior Arts

An injection molding machine is a machine for manufacturing plastic articles by an injection molding process. Generally, a conventional injection molding machine has a die, and molten plastic is injected into the die to form a solid plastic article. Injection molding machines are classified primarily by driving devices into hydraulic, mechanical and electric injection molding machines.

A driving device of a conventional hydraulic injection molding machine is a hydraulic cylinder. However, the hydraulic cylinder is relatively bulky and the hydraulic cylinder may produce noise during operation. Further, when the hydraulic cylinder has been actuated repeatedly, oil leakage will occur.

A driving device of a conventional electric injection molding machine is a servomotor. The servomotor is small in size so the electric injection molding machine is convenient to install. Besides, the servomotor does not produce noise during operation so provides a noiseless operation. However, power of only one servomotor is not sufficient, the die may lack sufficient strength and speed so operation efficiency of the conventional electric injection molding machine is reduced. Therefore, to develop an electric injection molding machine with more efficiency is needed.

To overcome the shortcomings, the present invention provides an electric injection molding machine to mitigate or obviate the aforementioned problems.

### SUMMARY OF THE INVENTION

The main object of the present invention is to provide an electric injection molding machine to improve actuation efficiency.

To achieve the foregoing objective, the electric injection molding machine in accordance with the present invention comprises a base, multiple connecting rods, a first driving device and a second driving device. The base has a first fixed board, a first moving board, a second moving board and a second fixed board. The second moving board has a first die. The second fixed board has a second die corresponding to the first die mounted on the second moving board. The connecting rods are mounted respectively through the first fixed board, first moving board, second moving board and second fixed board. The first driving device is mounted between the first fixed board and first moving board and has a first servomotor. The second driving device is mounted between the second moving board and second fixed board and has a second servomotor. The two servomotors provide power to drive the first and second moving boards to move along the connecting rods. Therefore, the first die mounted on the second moving board receives sufficient strength and speed so operation of the electric injection molding machine is efficient and smooth.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an electric injection molding machine in accordance with the present invention;

FIG. 2 is an enlarged exploded perspective view of a first driving device of the electric injection molding machine in FIG. 1;

FIG. 3 is an enlarged exploded perspective view of a second driving device of the electric injection molding machine in FIG. 1;

FIG. 4 is an enlarged side view of the electric injection molding machine in FIG. 1; and

FIG. 5 is an enlarged operational side view of the electric injection molding machine in FIG. 1 showing the first and second driving devices being in operation.

### DETAILED DESCRIPTION OF THE PREFERRED EMBODIMENTS

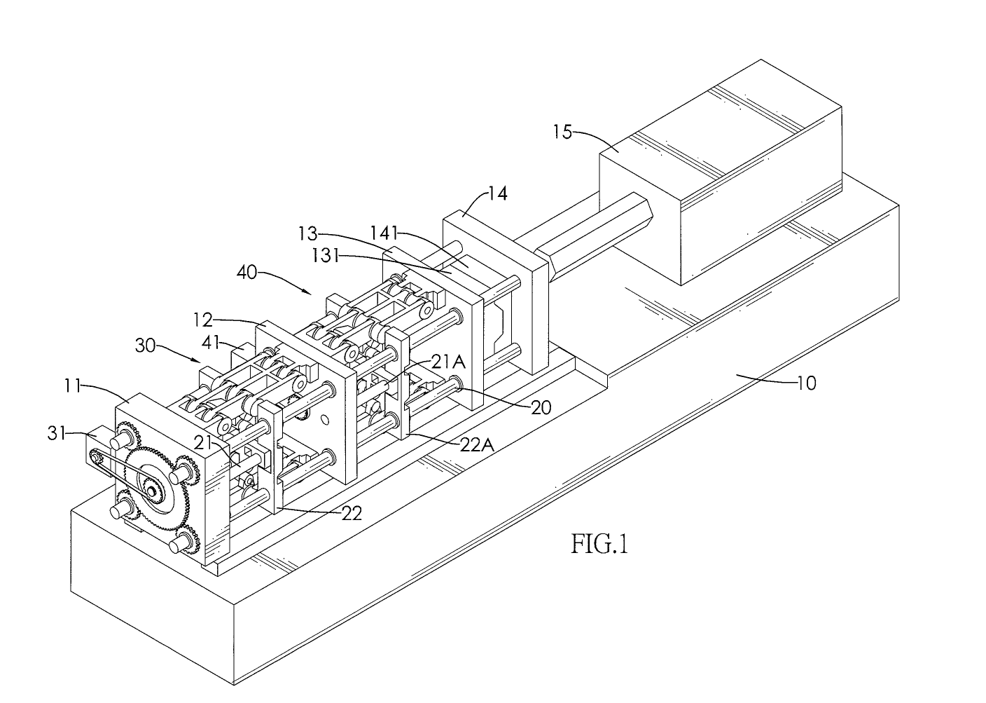

With reference to FIG. 1, an electric injection molding machine in accordance with the present invention comprises a base 10, multiple connecting rods 20, a first driving device 30 and a second driving device 40.

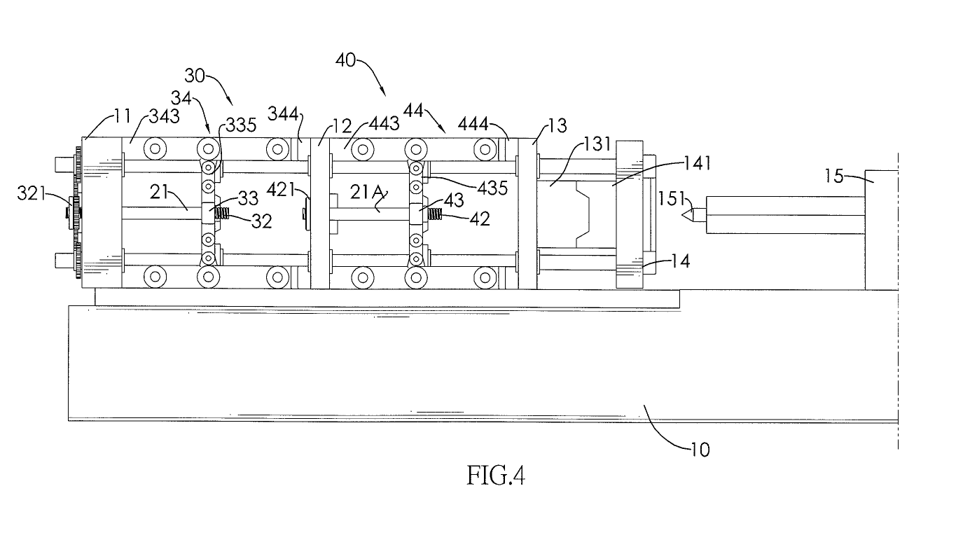

The base 10 has a first fixed board 11, a first moving board 12, a second moving board 13, a second fixed board 14 and a plastic cask 15. The first fixed board 11, first moving board 12, second moving board 13 and second fixed board 14 are rectangular and are mounted on the top of the base 10 in sequence and at intervals. The second moving board 13 has a side surface and a first die 131. The first die 131 is mounted on the side surface of the second moving board 13. The second fixed board 14 has a side surface and a second die 141. The second die 141 is mounted on the side surface of the second fixed board 14 and corresponds to the first die 131 mounted on the second moving board 13. The plastic cask 15 is mounted on the base 10. With further reference to FIG. 4, the plastic cask 15 has a nozzle 151 extending toward the second fixed board 14.

Each connecting rod 20 is mounted through one group of corresponding corners of the first fixed board 11, first moving board 12, second moving board 13 and second fixed board 14. Each connecting rod 20 has two ends respectively mounted securely on the first fixed board 11 and the second fixed board 14. The first moving board 12 and the second moving board 13 are mounted movably along the connecting rods 20.

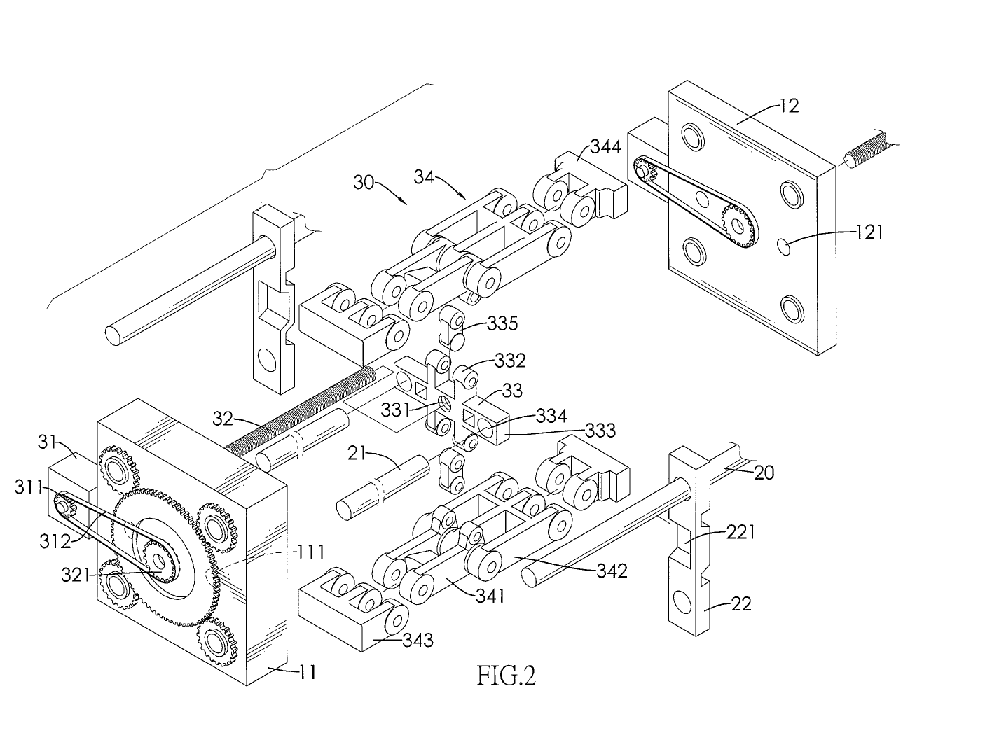

The first driving device 30 and the second driving device 40 may have the same structure. With further reference to FIG. 2, the first driving device 30 is mounted between the first fixed board 11 and first moving board 12 and has a first servomotor 31, a first driving rod 32 and a first linkage assembly. The first servomotor 31 is mounted on the first fixed board 11 and has a shaft connected to a first driving gear 311. The first fixed board 11 has a hole and a first bearing is mounted in the hole. The first driving rod 32 is mounted rotatably through the first fixed board 11 and has two ends and a threaded part. One of the ends of the first driving rod 32 is mounted through the first bearing and protrudes out of the hole of the first fixed board 11 and is connected to a first driven gear 321. A first driving belt 312 is mounted around the first driving gear 311 and first driven gear 321.

The first linkage assembly is mounted between the first fixed board 11 and first moving board 12 and has a first driving block 33, two first pivoting arms 335 and two first linking units 34. The first driving block 33 is mounted on the other end of the first driving rod 32 and has a threaded hole 331 and two pivoting parts 332. The threaded hole 331 is screwed with the threaded part of the first driving rod 32. The pivoting parts 332 protrude respectively from top and bottom surfaces of the first driving block 33. The first pivoting arms 335 are respectively connected pivotally to the first driving block 33. Each first pivoting arm 335 has a pivoting end and a moving end. The pivoting end of the first pivoting arm 335 is connected pivotally to one of the pivoting parts 332 of the first driving block 33.

The first linking units 34 are respectively connected pivotally to the first pivoting arms 335 and are respectively positioned above and below the first driving block 33. Each first linking unit 34 has a pivoting rod 341, a driven rod 342, a pivoting block 343 and a driven block 344. The pivoting rod 341 and the driven rod 342 are connected pivotally to each other. The pivoting rod 341 has a pivoting end and a connecting end. The driven rod 342 has a pivoting end and a connecting end. The pivoting end of the pivoting rod 341 is connected pivotally to the pivoting end of the driven rod 342 and a connecting part of the pivoting rod 341 and driven rod 342 is connected pivotally to the moving end of a corresponding first pivoting arm 335. The pivoting block 343 is connected pivotally to the connecting end of the pivoting rod 341 and is mounted securely on the first fixed board 11. The driven block 344 is connected pivotally to the connecting end of the driven rod 342 and is mounted securely on the first moving board 12.

The first fixed board 11 further has two guiding holes 111. The first driving block 33 further has two side protrusions 333 and two guiding holes 334. The side protrusions 333 protrude respectively from two opposite sides of the first driving block 33. The guiding holes 334 are foil led respectively through the side protrusions 333 and aligning with the guiding holes 111 of the first fixed board 11. Two first guiding rods 21 are mounted between the first fixed board 11 and the first driving block 33 and each first guiding rod 21 has a mounting end and an abutting end. The mounting end of the first guiding rod 21 is mounted securely in one of the guiding holes 111 of the first fixed board 11 and the abutting end of the first guiding rod 21 is mounted movably through a corresponding guiding hole 334 of the first driving block 33. Two first abutting blocks 22 are respectively mounted securely on the connecting rods 20 between the first fixed board 11 and first moving board 12. Each first abutting block 22 has a recess 221 corresponding to and selectively holding one of the side protrusions 333 of the first driving block 33 and having a recess surface. The abutting end of the first guiding rod 21 abuts the recess surface of a corresponding recess 221 of the first abutting block 22.

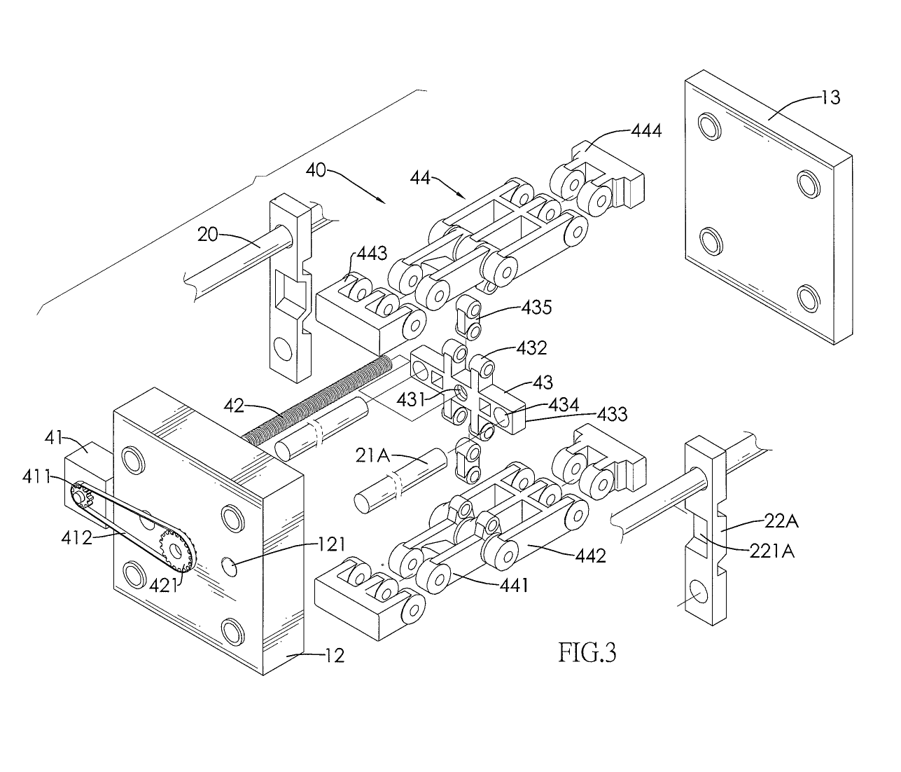

With further reference to FIG. 3, the second driving device 40 is mounted between the first moving board 12 and second moving board 13 and has a second servomotor 41, a second driving rod 42 and a second linkage assembly. The second servomotor 41 is mounted on the first moving board 12 and has a shaft connected to a second driving gear 411. The first moving board 12 has a hole and a second bearing is mounted in the hole. The second driving rod 42 is mounted rotatably through the first moving board 12 and has two ends and a threaded part. One of the ends of the second driving rod 42 is mounted through the second bearing and protrudes out of the hole of the first moving board 12 and is connected to a second driven gear 421. A second driving belt 412 is mounted around the second driving gear 411 and second driven gear 421.

The second linkage assembly is mounted between the first moving board 12 and second moving board 13 and has a second driving block 43, two second pivoting arms 435 and two second linking units 44. The second driving block 43 is mounted on the other end of the second driving rod 42 and has a threaded hole 431 and two pivoting parts 432. The threaded hole 431 is screwed with the threaded part of the second driving rod 42. The pivoting parts 432 protrude respectively from top and bottom surfaces of the second driving block 43. The second pivoting arms 435 are respectively connected pivotally to the second driving block 43. Each second pivoting arm 435 has a pivoting end and a moving end. The pivoting end of the second pivoting arm 435 is connected pivotally to one of the pivoting parts 432 of the second driving block 43.

The second linking units 44 are respectively connected pivotally to the second pivoting arms 435 and are respectively positioned above and below the second driving block 43. Each second linking unit 44 has a pivoting rod 441, a driven rod 442, a pivoting block 443 and a driven block 444. The pivoting rod 441 and the driven rod 442 are connected pivotally to each other. The pivoting rod 441 has a pivoting end and a connecting end. The driven rod 442 has a pivoting end and a connecting end. The pivoting end of the pivoting rod 441 is connected pivotally to the pivoting end of the driven rod 442 and a connecting part of the pivoting rod 441 and driven rod 442 is connected pivotally to the moving end of the corresponding second pivoting arm 435. The pivoting block 443 is connected pivotally to the connecting end of the pivoting rod 441 and is mounted securely on the first moving board 12. The driven block 444 is connected pivotally to the connecting end of the driven rod 442 and is mounted securely on the second moving board 13.

The first moving board 12 further has two guiding holes 121. The second driving block 43 further has two side protrusions 433 and two guiding holes 434. The side protrusions 433 protrude respectively from two opposite sides of the second driving block 43. The guiding holes 434 are formed respectively through the side protrusions 433 and aligning with the guiding holes 121 of the first moving board 12. Two second guiding rods 21A are mounted between the first moving board 12 and the second driving block 43 and each second guiding rod 21A has a mounting end and an abutting end. The mounting end of the second guiding rod 21A is mounted securely in one of the guiding holes 121 of the first moving board 12 and the abutting end of the second guiding rod 21A is mounted movably through a corresponding guiding hole 334 of the second driving block 43. Two second abutting blocks 22A are respectively mounted securely on the connecting rods 20 between the first moving board 12 and second moving board 13. Each second abutting blocks 22A has a recess 221A corresponding to and selectively holding one of the side protrusions 433 of the second driving block 43 and having a recess surface. The abutting end of the second guiding rod 21A abuts the recess surface of the corresponding recess 221A of the second abutting block 22A.

With reference to FIGS. 1 and 4, when the electric injection molding machine in accordance with the present invention is operated, the first servomotor 31 is actuated to drive the first linkage assembly to push or pull the first moving board 12 to move and the second servomotor 41 is actuated to drive the second linkage assembly to push or pull the second moving board 13 to move. Thus, the first die 131 mounted on the second moving board 13 can move toward and away from the second die 141 mounted on the second fixed board 14 to achieve molding process and molten plastic inside the plastic cask 15 is injected between the dies 131, 141 to form a solid plastic article.

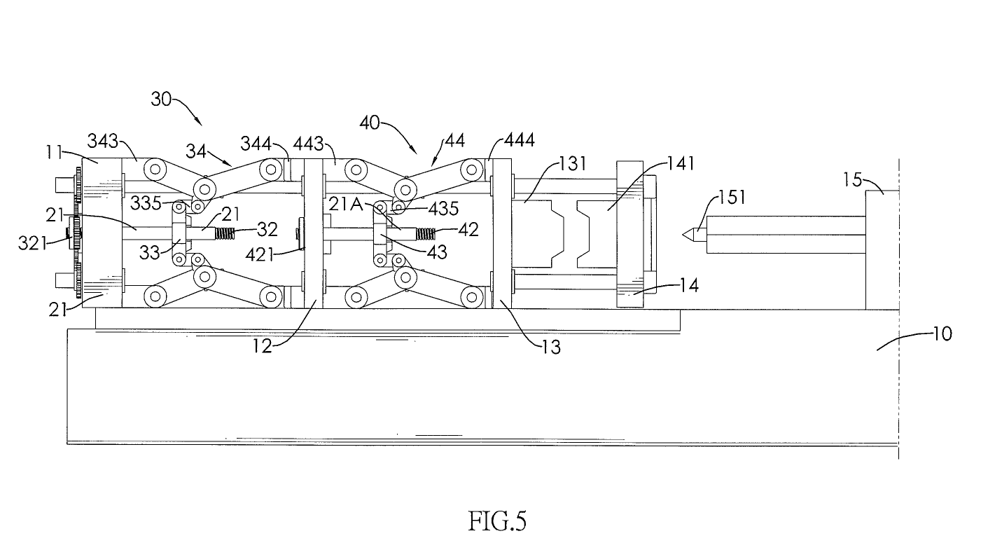

When the first and second servomotors 31, 41 are controlled to rotate in the same direction, power provided from the first and second servomotors 31, 41 drives the first and second driving rods 32, 42 to rotate via the first and second driving belts 312, 412. The rotating first and second driving rods 32, 42 drive the first and second driving blocks 33, 43 to move left as shown in FIG. 5. Then, the first and second pivoting arms 335, 435 and the first and second linking units 34, 44 are driven to rotate and the first and second moving boards 12, 13 are driven to move away from the second fixed board 14 to make the first die 131 move away from the second die 141 as well.

When the first and second servomotors 31, 41 are controlled to rotate reversely, the first and second driving blocks 33, 43 are driven to move right as shown in FIG. 4 and the first and second moving boards 12, 13 are driven to move toward the second fixed board 14 to make the first die 131 move toward the second die 141 as well. The first and second driving blocks 33, 43 move toward the second fixed board 14 until the side protrusions 333, 433 of the first and second driving blocks 33, 43 abut the recess surfaces of the recesses 221, 221A of the first and second abutting blocks 22, 22A. Consequently, the dies 131, 141 are kept from being bumped into each other and the first and second driving blocks 33, 43 are prevented from departing from the first and second driving rods 32, 42.

The electric injection molding machine in accordance with the present invention has two servomotors 31, 41 providing sufficient power to drive the first and second moving boards 12, 13 to move along the connecting rods 20. Therefore, the first die 131 receives sufficient strength and speed so operation of the electric injection molding machine is efficient and smooth.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An electric injection molding machine comprising:
a base having
a first fixed board, a first moving board, a second moving board and a second fixed board mounted on a top of the base in sequence and at intervals, the second moving board having a first die, the second fixed board having a second die corresponding to the first die mounted on the second moving board;
multiple connecting rods, each connecting rod mounted through the first fixed board, first moving board, second moving board and second fixed board, each connecting rod having two ends respectively mounted securely on the first fixed board and the second fixed board, and the first moving board and the second moving board mounted movably along the connecting rods;
a first driving device mounted between the first fixed board and first moving board and having a first servomotor; and
a second driving device mounted between the first moving board and second moving board and having a second servomotor.

2. The electric injection molding machine as claimed in claim 1, wherein
the first servomotor of the first driving device is mounted on the first fixed board and has a first driving gear;
the first driving device further has
a first driving rod mounted rotatably through the first fixed board and having
two ends, one of the ends protruding out of the first fixed board and connected to a first driven gear and a first driving belt mounted around the first driving gear and first driven gear; and
a threaded part; and
a first linkage assembly mounted between the first fixed board and first moving board and having
first driving block mounted on the other end of the first driving rod and having
a threaded hole screwed with the threaded part of the first driving rod; and
two pivoting parts protruding respectively from the first driving block;
two first pivoting arms respectively connected pivotally to the first driving block, each first pivoting arm having
a pivoting end connected pivotally to one of the pivoting parts of the first driving block; and
a moving end; and
two first linking units respectively connected pivotally to the first pivoting arms, each first linking unit having
a pivoting rod and a driven rod connected pivotally to each other, the pivoting rod having a pivoting end and a connecting end, the driven rod having a pivoting end and a connecting end, the pivoting end of the pivoting rod connected pivotally to the pivoting end of the driven rod and a connecting part of the pivoting rod and driven rod connected pivotally to the moving end of a corresponding first pivoting arm;
a pivoting block connected pivotally to the connecting end of the pivoting rod and mounted securely on the first fixed board; and
a driven block connected pivotally to the connecting end of the driven rod and mounted securely on the first moving board.

3. The electric injection molding machine as claimed in claim 2, wherein
the second servomotor of the second driving device is mounted on the first moving board and has a second driving gear;
the second driving device further has
a second driving rod mounted rotatably through the first moving board and having
two ends, one of the ends protruding out of the first moving board and connected to a second driven gear and a second driving belt mounted around the second driving gear and second driven gear; and
a threaded part; and
a second linkage assembly mounted between the first moving board and second moving board and having
a second driving block mounted on the other end of the second driving rod and having
a threaded hole screwed with the threaded part of the second driving rod; and
two pivoting parts protruding respectively from the second driving block;
two second pivoting arms respectively connected pivotally to the second driving block, each second pivoting arm having
a pivoting end connected pivotally to one of the pivoting parts of the second driving block; and
a moving end; and
two second linking units respectively connected pivotally to the second pivoting arms, each second linking unit having
a pivoting rod and a driven rod connected pivotally to each other, the pivoting rod having a pivoting end and a connecting end, the driven rod having a pivoting end and a connecting end, the pivoting end of the pivoting rod connected pivotally to the pivoting end of the driven rod and a connecting part of the pivoting rod and driven rod connected pivotally to the moving end of a corresponding second pivoting arm;
a pivoting block connected pivotally to the connecting end of the pivoting rod and mounted securely on the first moving board; and
a driven block connected pivotally to the connecting end of the driven rod and mounted securely on the second moving board.

4. The electric injection molding machine as claimed in claim 2, wherein
the first fixed board has two guiding holes;
the first driving block of the first linkage assembly further has
two side protrusions; and
two guiding holes formed respectively through the side protrusions and aligning with the guiding holes of the first fixed board;
two first guiding rods are mounted between the first fixed board and the first driving block, each first guiding rod has
a mounting end mounted securely in one of the guiding holes of the first fixed board; and
an abutting end mounted movably through a corresponding guiding hole of the first driving block; and
two first abutting blocks are respectively mounted securely on the connecting rods between the first fixed board and first moving board, each first abutting block has a recess corresponding to one of the side protrusions of the first driving block and having a recess surface, and the abutting end of the first guiding rod abuts the recess surface of a corresponding recess of the first abutting block.

5. The electric injection molding machine as claimed in claim 3, wherein
the first moving board has two guiding holes;
the second driving block of the second linkage assembly further has
two side protrusions; and
two guiding holes formed respectively through the side protrusions and aligning with the guiding holes of the first moving board;
two second guiding rods are mounted between the first moving board and the second driving block, each second guiding rod has
a mounting end mounted securely in one of the guiding holes of the first moving board; and
an abutting end mounted movably through a corresponding guiding hole of the second driving block; and
two second abutting blocks are respectively mounted securely on the connecting rods between the first moving board and second moving board, each second abutting block has a recess corresponding to one of the side protrusions of the second driving block and having a recess surface, and the abutting end of the second guiding rod abuts the recess surface of a corresponding recess of the second abutting block.

6. The electric injection molding machine as claimed in claim 1, wherein the base further has a plastic cask mounted on the base and having a nozzle extending toward the second fixed board.

7. The electric injection molding machine as claimed in claim 2, wherein the base further has a plastic cask mounted on the base and having a nozzle extending toward the second fixed board.

8. The electric injection molding machine as claimed in claim 3, wherein the base further has a plastic cask mounted on the base and having a nozzle extending toward the second fixed board.

9. The electric injection molding machine as claimed in claim 4, wherein the base further has a plastic cask mounted on the base and having a nozzle extending toward the second fixed board.

10. The electric injection molding machine as claimed in claim 5, wherein the base further has a plastic cask mounted on the base and having a nozzle extending toward the second fixed board.
